(19) United States
(12) Patent Application Publication
(10) Pub. No.: US 2016/0151695 A1
(43) Pub. Date: Jun. 2, 2016

(54) STATIONARY SWIMMING POOL

(71) Applicant: Vinicius PACHECO MOREIRA AMORIM, (US)

(72) Inventor: Vinicius PACHECO MOREIRA AMORIM, São José dos Campos (BR)

(21) Appl. No.: 14/780,511

(22) PCT Filed: Dec. 17, 2014
(86) PCT No.: PCT/BR2014/000445

§ 371 Date: Jan. 4, 2016

(30) Foreign Application Priority Data
Dec. 17, 2013 (BR) BR102013032416-7

(51) Int. Cl. A63B 69/12; A63B 24/00; G01L 5/10; E04H 4/00; E04H 4/08

(52) U.S. Cl. CPC A63B 69/12; E04H 4/0018; E04H 4/082; G01L 5/103; A63B 24/0062

(57) ABSTRACT

The present invention refers to a stationary swimming pool (1) which comprises a structural system having a modular design, with a tank (3), a stationary swimming device connected to the structural system and to an in-place swimmer in the tank (3), a strain measurement device (6) associated with the stationary swimming device and mounted on the structural system, a training monitoring system which receives and processes the information from the strain measurement device, and an internal display system (8) capable of displaying both information received from the monitoring system and information for entertaining the swimmer.

The present invention further refers to a station for practicing stationary swimming, comprising one or more pools as previously defined.

The present invention refers to a stationary swimming pool. More precisely, the present invention refers to a portable stationary swimming pool that occupies a small area and that has a system to monitor training and an entertainment system.

### DESCRIPTION OF THE STATE OF THE ART

Swimming pools are widely use for the practice of physical exercise and sports, such as hydrogymnastics, swimming and water polo, besides being used as recreation places.

Normally the pools at fitness centers and sports clubs, which are used for physical exercise, have a minimum standard size of twenty-five meters long by two meters wide, also known as semi-Olympic pools, since this size occupies a smaller area than an Olympic pool. These pools have an average of eight lanes, for a total occupied area of approximately four hundred square meters.

To optimize the space occupied, it is common for fitness centers and swimming schools to place two students in each lane, so that each student uses an area of twenty-five square meters instead of fifty square meters provided by the pool's lane, without counting the spaces at the edges and for circulation.

In any event, this type of pool uses a very large quantity of water, approximately 700,000 liters, which demands a structure for installation with powerful equipment for treatment of water and to maintain the ideal temperature for swimming. Besides the additional space needed for this equipment, there is large expenditure on water and electricity associated with the equipment.

Therefore, the known solutions for swimming training are generally not very practical, occupy a large space and have a considerable maintenance cost.

A solution found in the state of the art to avoid these inconveniences was the creation of pools and equipment for stationary swimming, including small pools in which the user is held by a cord or swims against a current, without moving in space.

One of these solutions is described in the document JPH11159173A, which describes a pool with a water current utilized for in-place swimming, equipped with video cameras connected to a detection system, which in turn is connected to a computer. The computer exhibits information on the athlete's performance, such as movement and speed.

The drawback of this solution is the fact that the pool with running water has a relatively large size when compared to other types of stationary swimming pools. Additionally, the cost of installation and maintenance is high, besides having high vibration and noise due to the components employed.

Another solution found in the state of the art is described by document U.S. Pat. No. 4,577,859, which shows a pool for in-place swimming equipped with an upper bar to hold the athlete by means of elastic cords. The pool also makes use of a chronometer, a digital panel that reports speed, loudspeakers and an alarm system.

However, this does not permit the user to receive instantaneous information about his or her training, such as the training time or distance swum. Besides this, the solution requires the instructor/coach to remain alongside the pool to give guidance, without the ability to orient other swimmers during the training period.

Another point that should be stressed is that none of the solutions found in the state of the art allows the user to have some type of entertainment during the training.

Hence, the state of the art does not include an in-place swimming pool that occupies a small area, that is portable and has compact and simple construction, with a user entertainment system that allows monitoring and feedback on the physical evolution of the athlete and that enables the instructor/coach to monitor more than one athlete at a time.

### OBJECTIVES OF THE INVENTION

One of the objectives of the present invention is to provide a pool for stationary swimming that occupies a small area and that is portable, while at the same time having simple and compact construction.

Another objective of the present invention is to provide a pool for stationary swimming that has a user entertainment system and that allows monitoring the athlete's physical evolution, with instantaneous transmission of monitoring data to the user and/or a coach/instructor.

Still another objective of the present invention is to provide a pool for stationary swimming that has modular construction, allowing installation of a set of pools arranged side by side, optimizing the space occupied.

A further objective of the present invention is to provide a strain measurement device for a stationary swimming device.

### BRIEF DESCRIPTION OF THE INVENTION

The present invention achieves these and other objectives through a stationary swimming pool comprising a modular structural construction system with a tank; a stationary swimming device connected to the structural system and a stationary swimmer in the tank; a strain measurement device associated with the stationary swimming device installed in the structural system; a system to monitor training that receives and processes the information from the strain measurement device; and an internal display system which can display both the information received from the monitoring system and entertainment information for the stationary swimmer.

In a preferred embodiment of the present invention, the pool further comprises an external display system capable of displaying information received from the monitoring system to a user who is out of the pool; at least one cover which covers and protects the contents of the tank; and a thermally insulating blanket that covers the tank and the cover.

Also in the preferred embodiment, the structural system further comprises a base structure which supports the tank, and the strain measurement device is installed on the base frame.

The internal display system may comprise a display screen installed at the bottom of the tank, with the screen being protected by a waterproof box, and the tank may further comprise a sound system and a camera.

Preferably, the stationary swimming device is a cable and the strain measurement device comprises a hook attached to one end of the cable, a pulley inserted into an inner housing and fixed to another end of the cable, and a load cell and a hinge fixed to an upper portion of a support bracket, which is fixed to an outer housing. The inner housing is supported in an upper portion of the load cell and fixed at the hinge, and a lid is coupled to an upper portion of the outer housing.

The present invention also includes a station for practicing stationary swimming comprising two or more pools as defined previously, where the station comprises an external display system to the pools, the display system being able to receive information from the training monitoring system of each of the pools, process the information received, and display the processed information to a user who is out of the pools.

The present invention also comprises a strain measurement device for a cable from a stationary swimming device comprising a hook fixed to one end of the cable, a pulley inserted into an inner housing and fixed to another end of the cable; a load cell and a hinge fixed to an upper portion of a support bracket, which is fixed to an external housing; the inner housing being supported in an upper portion of the load cell and fixed at the hinge; and a cover being coupled to an upper portion of the outer housing.

### BRIEF DESCRIPTION OF DRAWINGS

The present invention will be described below in more detail with reference to the accompanying drawings, in which:

FIG. 1—is a perspective view of a closed stationary swimming pool, according to a preferred embodiment of the present invention;

FIG. 2—is a perspective view of the open stationary swimming pool;

FIG. 3—is an exploded view of the stationary swimming pool;

FIG. 4—is a top view of the tank with the internal display system;

FIG. 5—is a perspective view showing the internal system;

FIG. 6—is a perspective view of the strain gauge;

FIG. 7—is an exploded view of the strain gauge;

FIG. 8—is a perspective view of the station for the practice of stationary swimming; and

FIG. 9—is a top view of the station for practicing stationary swimming.

### DETAILED DESCRIPTION OF THE FIGURES

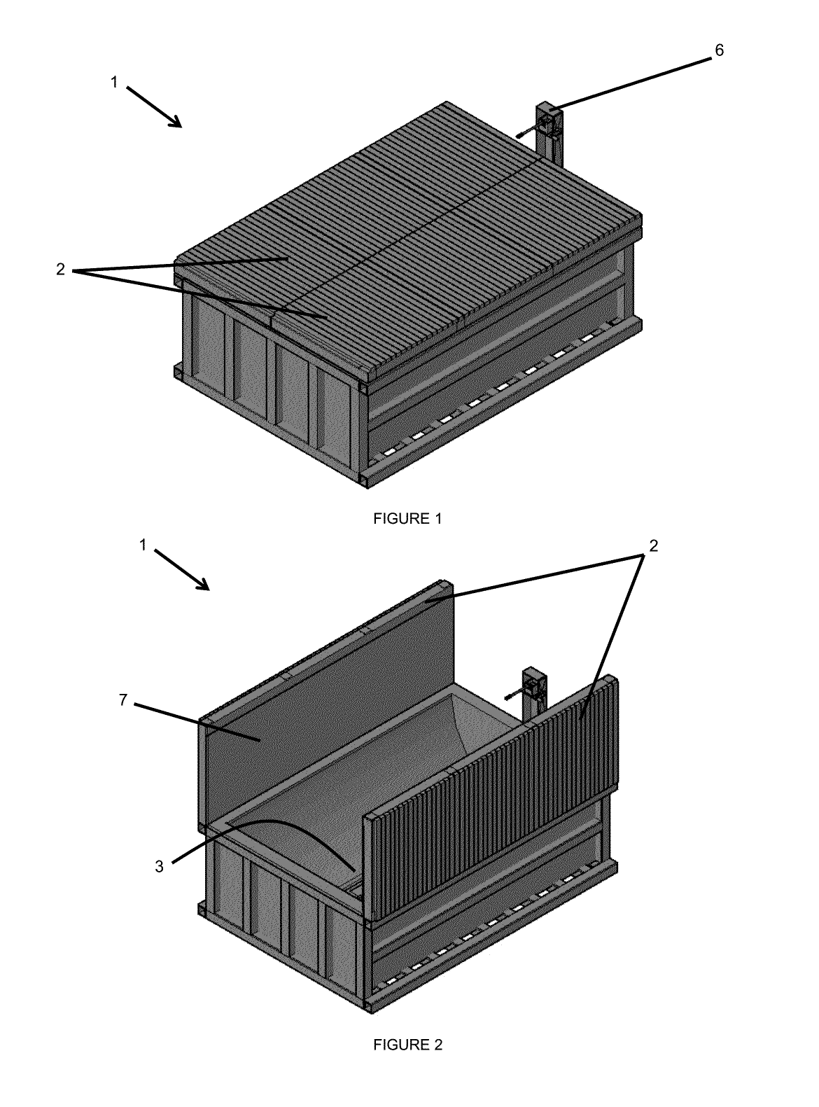

FIGS. 1 to 7 illustrate a stationary swimming pool in a preferred embodiment of the present invention.

As can be seen in FIGS. 1 and 7, the stationary swimming pool 1 comprises a modular structural construction system, a tank 3, a stationary swimming device, a strain measurement device 6, a training monitoring system and an internal display system 8.

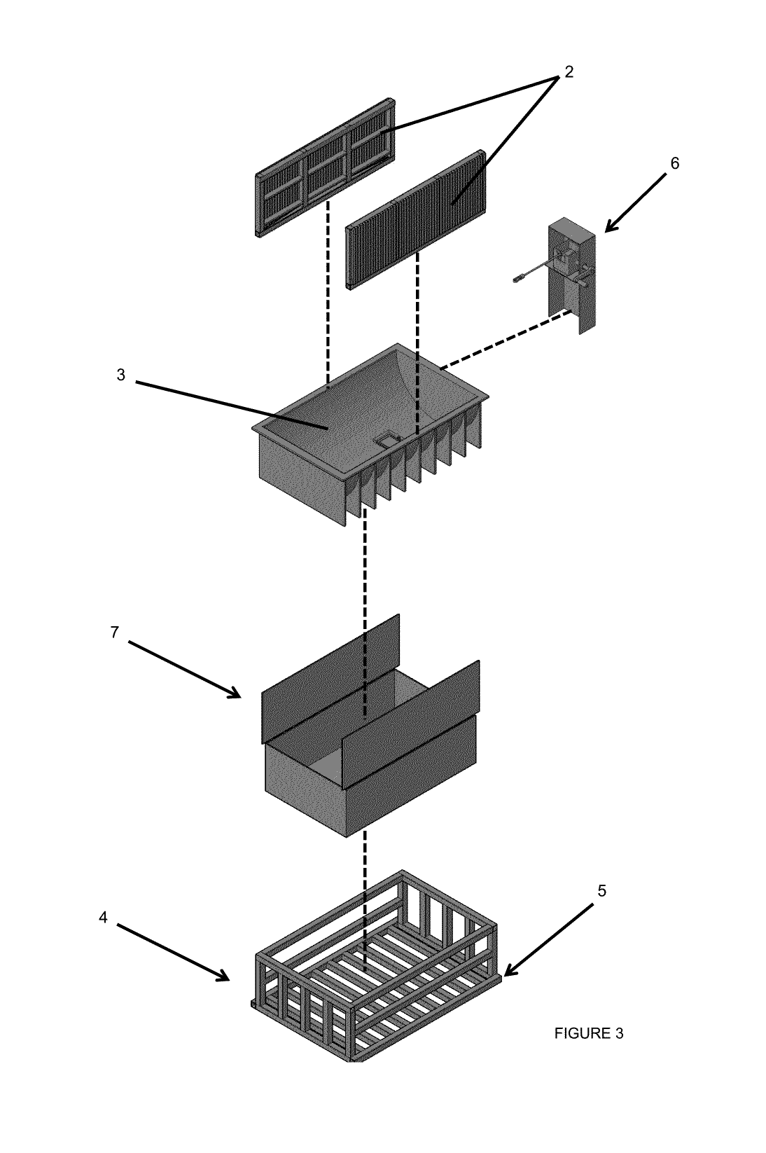

The modular structural construction system in a preferred embodiment consists of a shoring frame 4. However, if necessary, the modular structural construction system can also comprise a support 5, as can be seen in FIG. 3.

The tank 3 is set at an inner portion of the modular structural construction system.

A cover 2 is attached to a side of the modular structural construction system.

The cover 2 aims to prevent the water inside the tank 3 from coming into contact with light, since when this occurs there is a proliferation of algae, which in turn create favorable conditions for the development of bacteria that can cause skin diseases and infections, besides turning the water green and imparting an unpleasant odor.

The cover 2 uses a hydraulic system (not shown) to perform opening and closing. Preferably, the system comprises two single-action hydraulic pistons, a pumping system and at least one return tank. The entire hydraulic system is connected by means of hoses.

The hydraulic pistons are fixed on the cover 2 and the bracing frame 4, and one end of the piston is fixed on the cover 2 and the other end is attached to the bracing frame 4.

The stationary swimming pool 1 further comprises a thermally insulating blanket 7 that covers the cover 2 and tank 3, as shown in FIG. 3. The thermally insulating blanket can be made of any suitable material, such as glass wool or expanded polyurethane foam. Naturally, any suitable similar material could be used.

In a preferred embodiment, the thermally insulating blanket 7 is placed between the modular structural construction system and the tank 3 and the ends of the thermally insulating blanket 7 are fixed on each cover 2. Thus, the blanket surrounds the whole tank 3 and maintains the water temperature.

The stationary swimming device, which is preferably a cable 62, is connected to the modular structural construction system and a stationary swimmer in the tank 3.

More precisely, the cable 62 is coupled to a belt (not shown), which is fixed in line with the swimmer's waist by an adhesive element and a clamp which contains a cardiac measurement monitor.

The cardiac measurement monitor comprises an elastic strap that emits a certain frequency, which will be decoded by a receiver near the user.

The strain measurement device 6 is associated with the stationary swimming device and is attached to the structural system.

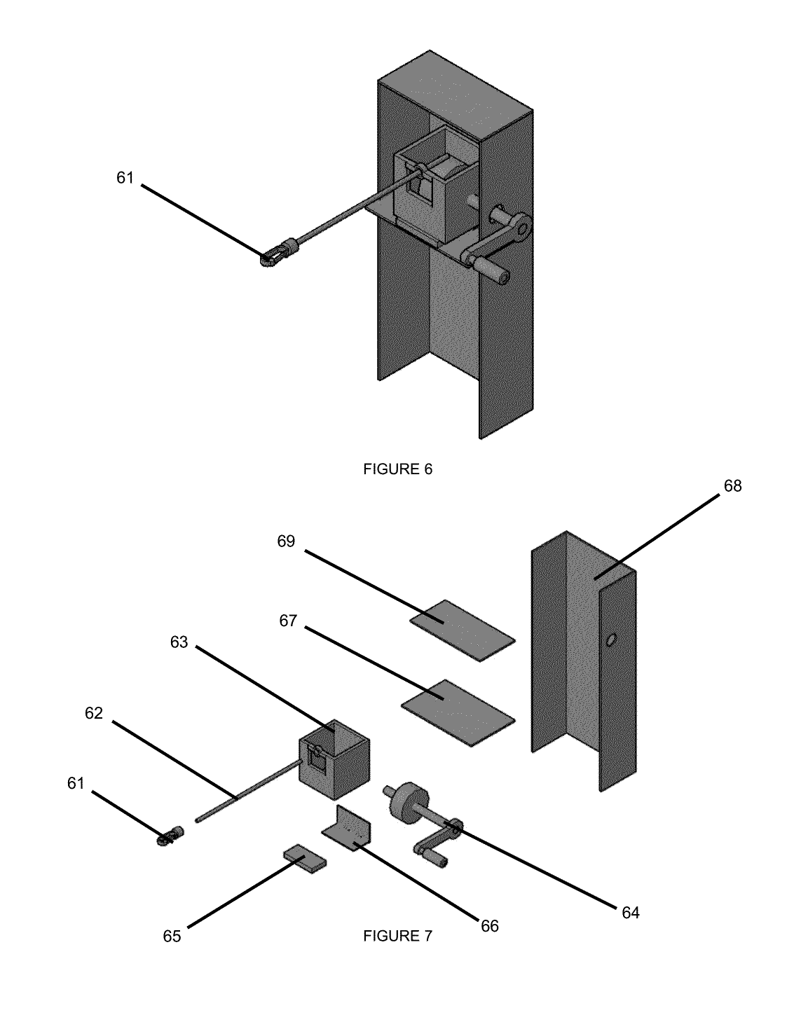

The strain measurement device 6 consists of a hook 61, an inner housing 63, a pulley 64, a load cell 65, a hinge 66, a support 67 supporting an outer housing 68 and a lid 69, as can be seen in FIGS. 6 and 7.

The hook 61 is fixed to one end of the cable 62; the other end of the cable 62 is fixed to the pulley 64, which in turn is inserted within the inner housing 63.

The inner housing 63 is supported on the load cell 65 and one of the fixed hinge ends 66.

The support bracket 67 is fixed to the outer housing 68 and its upper portion is fixed to the other end of the hinge 66 and load cell 65.

The lid 69 is coupled to an upper portion of the outer housing 68.

The purpose of the strain measurement device 6 is to measure the strain on the cable 62 provided by the user of the stationary swimming pool 1, more specifically, device 6 measures the strain on the cable 62 in real time, performing a number of measurements per second.

The hinge 66 and load cell 65 are used so that the strain measurement device 6 can make a valid measurement, since with the use of these elements there is no interference of any load and no strain provided by the cable is lost.

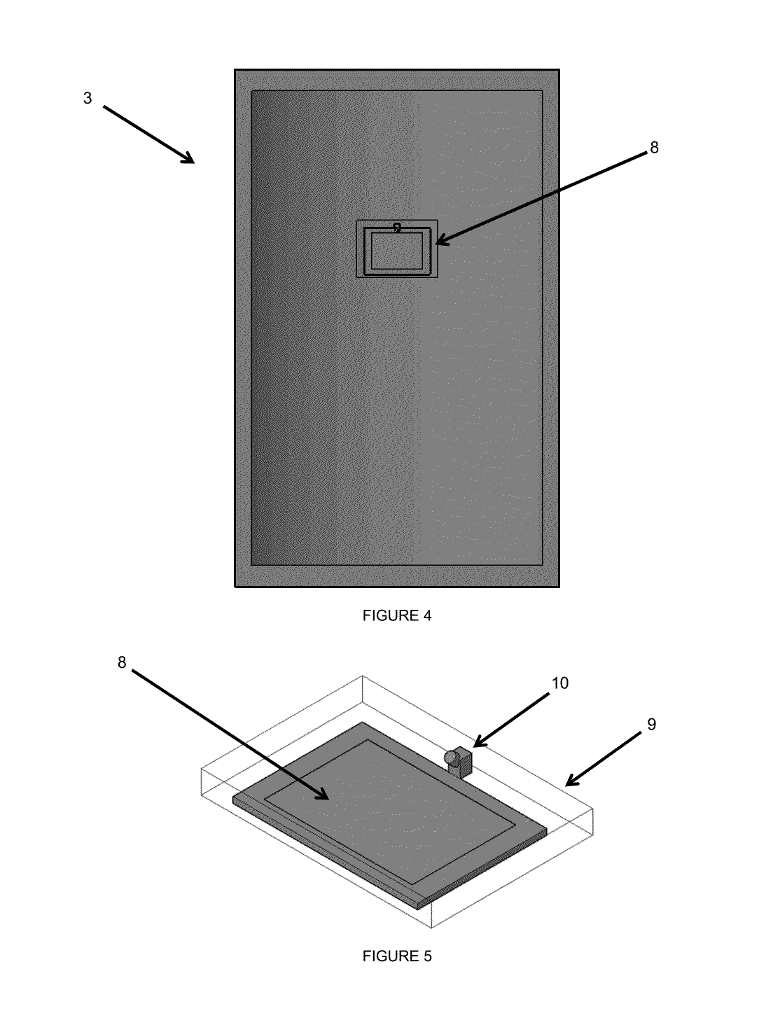

As can be seen in FIGS. 4 and 5, an internal display system 8 is inserted inside the tank 3 and comprises a display screen protected by a waterproof box 9, preferably with IP68 degree of protection.

Additionally, a pair of tubes is fixed diametrically opposed in the waterproof box 9, one an inlet and one an outlet. The pair of tubes has the function of protecting the power cables and the signal system in addition to being coupled to a ventilation system (not shown) provided with at least two fans, the fans being installed at the inlet and outlet of the box.

The internal display system 8 has two display functions: a sports function, which allows one to track all instant information of the workout, and the entertainment function, which allows the user to select a program to be displayed on the monitor, for example, a TV channel or videos from the Internet.

When the system is in the entertainment function, the user can still leave the training information in the background (picture in picture).

The purpose of the ventilation system is to perform forced ventilation, and a fan installed in the inlet tube is used to force the air into the system, and another, installed in the outlet tube, is used to suck the air out.

The internal display system 8 is preferably a 22-inch TV. However, other types of devices can be used, for example, a tablet or an image generated by a projector.

The box 9 is manufactured preferably of acrylic. However, other types of materials can be used provided that the purpose of protecting the internal display system 8 is met.

A sound system (not shown) and a camera 10 are coupled to the internal display system 8 and are inserted in the tank 3.

The sound system is preferably a waterproof headset and aims to enable the user to hear the audio from the internal display system 8 and/or listen to the guidance from the instructor/coach who is outside the stationary swimming pool 1.

The training monitoring system is preferably a computer program that is used to record and display simultaneously the readings performed by the strain measurement device 6. More precisely, the training monitoring system records the pulses generated in the load cell 65, interprets and displays training information on the internal display system 8 and another display system outside the stationary swimming pool 1, such as, for example, the following: the training time, swimming distance, instantaneous velocity, calorie expenditure, cardiac rate, respiratory rate and performance over a predetermined number of consecutive training sessions (for example, five or more consecutive sessions). In this sense, information such as cardiac and respiratory rates can be particularly useful for stationary swimming pools used for therapeutic purposes in clinics or hospitals.

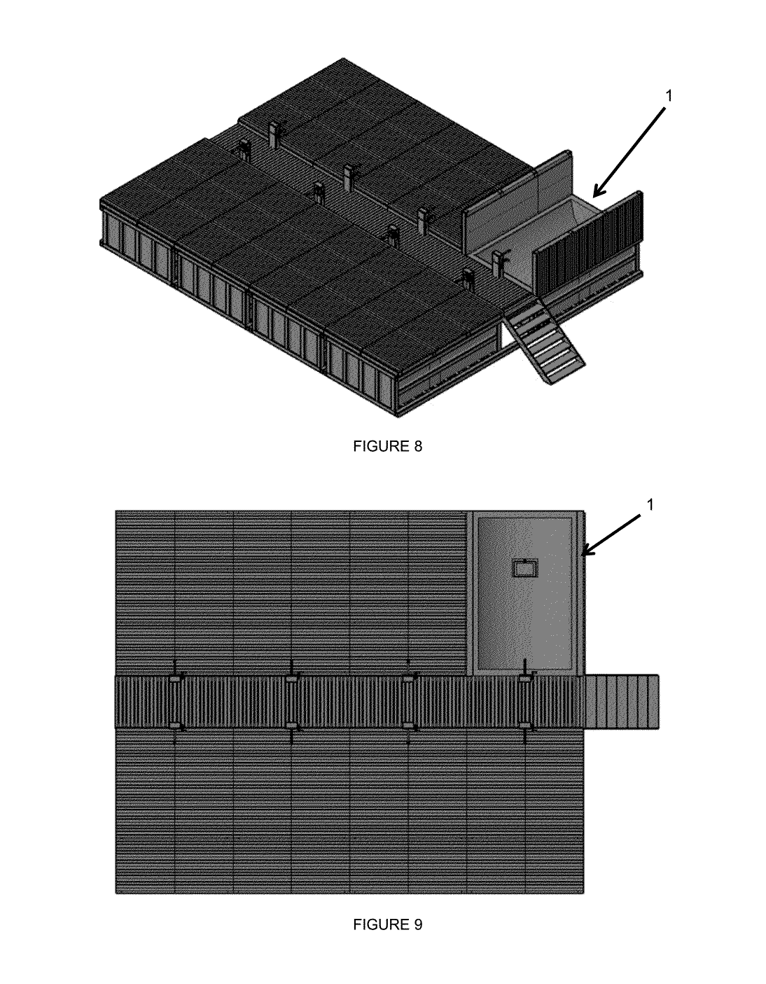

Additionally, the training monitoring system is preferably configured to monitor the training in only one stationary swimming pool 1, but its configuration allows it to monitor an entire station for practicing stationary swimming, which may include up to eight stationary pools 1, as can be seen in FIGS. 8 and 9.

In addition, the computer program is further configured to control all the automated functions of the pools: the opening and closing of the covers 2, water condition settings and automatically activated valves.

The external display system is preferably a computer. However, other types of display systems can be used, for example a tablet or a smartphone.

The stationary swimming pool 1 further has a water treatment and conditioning system (not shown), which is provided with at least one filter, a pump, a resistance for heating the water, tubes and electrical panel.

This system employed is similar to a treatment system used in conventional pools.

Additionally, the stationary swimming pool 1 comprises an electrical wire bed system, inside of which are the electrical wires for signals and grounding, sized for the entire system. The electrical system may comprise a single module or a multiple module of eight.

Hence, a stationary swimming pool 1 is achieve that occupies a small area, approximately eight square meters, and uses only 3800 liters of water. Another advantage presented by the stationary swimming pool 1 is the fact that it is a portable device, allowing easy installation and de-installation.

Furthermore, the stationary swimming pool 1 allows the instructor/coach to monitor the athlete's physical progress and allows orientation of more than one athlete simultaneously, with the instructor/coach able to monitor and guide drills in up to eight pools simultaneously through a central area in the fitness center or from home via the Internet, sending his voice and image, by means of the internal display 8 and sound system to each user at different times and even different places.

The stationary swimming pool 1 also has the advantage of an entertainment function, which allows the user to choose the programming of the internal display system 8.

In addition, the stationary swimming pool 1 has the advantage that it can be used by users of different heights and sizes, since it is possible to adjust the length of the cable 62 from the pulley 64 according to the user's height, without this operation interfering with the load measurement cell 65.

As shown in FIGS. 8 and 9, the modular feature of the pool of the present invention enables the installation of a station for the practice of in-place swimming composed of a plurality of pools. In this case, the cover 2 and protection of the tanks can be used as a platform for the movement of users.

Having described an example of a preferred embodiment of the present invention, it should be understood that the scope of the present invention encompasses other possible variations, being limited solely by the wording of the appended claims, including therein the possible equivalents.

1. A stationary swimming pool (1) characterized by the fact it comprises: a modular structural construction system with a tank (3);
a stationary swimming device connected to the structural system and a stationary swimmer in the tank (3);
a strain measurement device (6) associated with the stationary swimming device and installed in the structural system;
a training monitoring system that receives and processes the information from the strain measurement device; and
an internal display system (8), which is capable of displaying both information received from the monitoring system and entertainment information for the stationary swimmer.

2. A stationary swimming pool (1) according to claim 1, characterized by the fact it further comprises an external display system capable of displaying information received from the monitoring system to a user who is out of the pool.

3. A stationary swimming pool (1) according to claim 1, characterized by the fact that it also comprises at least one cover (2), which covers and protects the contents of the tank (3).

4. A stationary swimming pool (1) according to claim 3, characterized by the fact that the pool further comprises a thermally insulating blanket (7) covering the tank (3) and the cover (2).

5. A stationary swimming pool (1) according to claim 4, characterized by the fact that the structural system further comprises a base structure which supports the tank (3), with the strain measurement device (6) being installed at the base of the structure.

6. A stationary swimming pool (1) according to claim 1, characterized by the fact that the internal display system (8) comprises a display screen installed on the tank bottom (3), the screen being protected by a waterproof box (9).

7. A stationary swimming pool (1) according to claim 1, characterized by the fact that the tank (3) further comprises a sound system installed in the tank (3) and a camera (10).

8. A stationary swimming pool (1) according to claim 1, characterized by the fact that the stationary swimming device is a cable (62).

9. A stationary swimming pool (1) according to claim 8, characterized by the fact that the strain measurement device (6) comprises
a hook (61) fixed to one end of the cable (62);
a pulley (64) inserted within an inner housing (63) and fixed to the other end of the cable (62);
a load cell (65) and a hinge (66) fixed at an upper portion of a support bracket (67), which is fixed to an outer housing (68);
the inner housing (63) being supported on an upper portion of the load cell (65) and fixed at the hinge (66);
and a lid (69) being coupled to an upper portion of the outer housing (68).

10. A station for stationary swimming comprising two or more pools as defined in claim 1, the station being characterized by the fact it comprises an display system outside the pools, the display system being capable of receiving information from the training monitoring system of each of the pools, processing the information received, and displaying the processed information to a user who is out of the pools.

11. A strain measurement device (6) for a cable (62) of a stationary swimming device characterized by the fact it comprises:
a hook (61) fixed to one end of the cable (62);
a pulley (64) inserted within an inner housing (63) and fixed to the other end of the cable (62);
a load cell (65) and a hinge (66) fixed to an upper portion of a support bracket (67), which is fixed to an outer housing (68);
the inner housing (63), being supported on an upper portion of the load cell (65) and fixed at the hinge (66); and
a lid (69) coupled to an upper portion of the outer housing (68).
